(19) United States
(12) Patent Application Publication
(10) Pub. No.: US 2014/0150115 A1
(43) Pub. Date: May 29, 2014

(54) ASSIGNING ELECTRONICALLY PURCHASED ITEMS OF CONTENT TO USERS

(71) Applicant: APPLE INC., Cupertino, CA (US)

(72) Inventors: Jean-Pierre Ciudad, Cupertino, CA (US); David Rahardja, Sunnyvale, CA (US); Christopher H. Bourdon, Cupertino, CA (US); Todd R. Fernandez, Mountain View, CA (US); Daniel I. Feldman, San Francisco, CA (US); Gregory Burns, Los Altos, CA (US); Jussi-Pekka Mantere, Mountain View, CA (US); Mark W. Whittemore, San Jose, CA (US); Christopher G. Skogen, San Jose, CA (US)

(73) Assignee: APPLE INC., Cupertino, CA (US)

(21) Appl. No.: 13/728,457

(22) Filed: Dec. 27, 2012

Related U.S. Application Data
(60) Provisional application No. 61/730,897, filed on Nov. 28, 2012.

(51) Int. Cl. G06F 21/10

(52) U.S. Cl. CPC G06F 21/10
USPC 726/28

(57) ABSTRACT

The described embodiments include a content provider device that can assign items of content (applications, digitally-rendered music, books, videos, etc.) to users upon receiving assignment messages from administrative devices. The items of content can be electronically transferred to the user's devices to be used by users. The content provider device can also revoke assignments of items of content from users upon receiving revocation messages from administrative devices. The revocation generally causes the loss of one or more rights to the item of content for the user. For example, the content provider device can stop providing services for the item of content and/or can cause the item of content to be deleted from a corresponding user's device.

### RELATED APPLICATION

This application is a non-provisional application from, and hereby claims priority under 35 U.S.C. §119 to, pending provisional U.S. patent application No. 61/730,897, which is titled “Assigning Electronically Purchased Items of Content to Users,” by Jean-Pierre Ciudad, David Rahardja, Christopher H. Bourdon, Todd R. Fernandez, Daniel I. Feldman, Gregory Burns, Jussi-Pekka Mantere, Mark W. Whittemore, and Christopher G. Skogen, which was filed on 28 Nov. 2012, (Attny Docket No. APL-P16932USP1) and which is herein incorporated by reference.

### BACKGROUND

1. Field

The described embodiments relate to electronic devices. More specifically, the described embodiments relate to assigning electronically purchased items of content to users.

2. Related Art

In the last decade, it has become commonplace for individual users to use electronic devices such as personal computing devices and smart phones to electronically purchase items of content such as digitally-rendered books, music, or video and applications from content providers using electronic networks such as the Internet. As the technology behind electronically providing content matures and electronic devices become more ubiquitous, businesses and institutions have also begun to use the technology for supplying content to their employees, students, etc. For example, businesses can provide work-related applications to employees for use within the scope of their employment or schools can provide applications and digitally-rendered books for use by students.

However, because many content providers are configured to complete transactions with individual users, the mechanisms provided to enable purchasing entities (e.g., businesses, institutions, etc.) to purchase and assign/transfer items of content to users may not provide the level of control over the items of content that the purchasing entities desire. For example, one existing technique to enable a purchasing entity to provide an item of content to a user involves the purchasing entity purchasing a license for the item of content and receiving a token (e.g., a redemption code, a digital certificate, etc.) for the item of content from the content provider. Next, the purchasing entity forwards the token to the user to whom the item of content is to be assigned. The user then uses the token to complete a purchase transaction with the content provider through the user's personal account, after which the user “owns” the item of content outright. Because the user owns the item of content, the purchasing entity has no control over the user's use of the item of content. For example, assuming that the item of content is an application assigned to an employee by an employer, because the employee owns the application, the employee can freely use the application, even after the employee leaves employment with the employer.

### SUMMARY

The described embodiments include a content provider device that assigns items of content to users. In some embodiments, the content provider device receives, from an administrative device, an assignment message comprising a first identifier for a user and an identification of at least one item of content from a set of items of content that is assigned to the user. The content provider device then updates a user-assignment table entry for the user to include the first identifier for the user and a listing of the at least one item of content from the set of items of content that is assigned to the user. Next, the content provider device receives from the user's device, a user identity message comprising the first identifier for the user and a second identifier for the user. The content provider then updates the user-assignment table entry for the user to include the second identifier for the user from the user identity message based on the first identifier for the user in the user identity message. The content provider uses the second identifier and the listing of the at least one item of content that is assigned to the user from the user-assignment table entry for the user to electronically transfer, from the content provider device to the user's device, the at least one item of content assigned to the user.

In some embodiments, prior to updating a user-assignment table entry for the user to include the listing of the at least one item of content from the set of items of content that is assigned to the user, the content provider device receives from a purchasing device, a purchase message for the set of items of content. In response to the purchase message, the content provider device creates a record of purchased items of content in the set of items of content, each purchased item of content in the set of items of content being separately assignable. The content provider device then uses the record of purchased items of content to verify that the at least one item of content is available for assignment.

In some embodiments, the content provider device receives, from the administrative device, a revocation message comprising a first identifier for a user and an identification of at least one item of content for which the assignment is to be revoked from the user. The content provider device then updates the user-assignment table entry for the user to remove the listing of the at least one item of content for which the assignment is to be revoked from the user. The content provider device then performs one or more operations to revoke the assignment of the item of content from the user.

In some embodiments, when performing one or more operations to revoke the assignment of the item of content from the user, the content provider device sends a reporting message to the user's device, the reporting message causing the user's device to display a message indicating that the at least one item of content is no longer assigned to the user.

In some embodiments, when performing one or more operations to revoke the assignment of the item of content from the user, the content provider device no longer provides services for the item of content for which the assignment was revoked from the user's device.

In some embodiments, the at least one item of content comprises an application that performs a number of functions on the user's device. In these embodiments, when performing the one or more operations to revoke the assignment of the item of content from the user, the content provider device sends a disabling message to the user's device, the disabling message causing the user's device to one of: (1) disable some or all of the functions performed by the application, or (2) remove the application from the user's device.

In some embodiments, the first identifier for the user is an administrative identifier for the user and the second identifier for the user is an account identifier for the user.

In some embodiments, the administrative device and the user's device are different devices.

In some embodiments, before using the second identifier and the listing of the at least one item of content that is assigned to the user from the user-assignment table entry for the user to electronically transfer, from the content provider device to the user's device, the at least one item of content assigned to the user, the content provider device receives, from the user's device, a request to electronically transfer, to the user's device, items of content that are assigned to the user, the request identifying the user by the second identifier for the user.

In some embodiments, the set of items of content includes at least one instance of at least one of an application or a digitally-rendered media file.

### BRIEF DESCRIPTION OF THE FIGURES

FIG. 1 presents a block diagram of an electronic device in accordance with the described embodiments.

FIG. 2 presents a block diagram illustrating a content provider device coupled via a network to an administrative device and a user device in accordance with the described embodiments.

FIG. 3 presents a block diagram illustrating exemplary messages communicated between a content provider device, an administrative device, and a user device while assigning an item of content to a user in accordance with the described embodiments.

FIG. 4 presents a block diagram illustrating an exemplary purchased list in a content provider device in accordance with the described embodiments.

FIG. 5 presents a block diagram illustrating an exemplary purchased list in an administrative device in accordance with the described embodiments.

FIG. 6 presents a block diagram illustrating an exemplary user-assignment table in an administrative device in accordance with the described embodiments.

FIG. 7 presents a block diagram illustrating an exemplary assignment message in accordance with the described embodiments.

FIG. 8 presents a block diagram illustrating an exemplary user-assignment table in a content provider device in accordance with the described embodiments.

FIG. 9 presents a block diagram illustrating an exemplary user identity message in accordance with the described embodiments.

FIG. 10 presents a block diagram illustrating an exemplary user-assignment table following an update of an entry for a user in accordance with the described embodiments.

FIG. 11 presents a block diagram illustrating exemplary messages communicated between a content provider device, an administrative device, and a user device while revoking the assignment of application to a user in accordance with the described embodiments.

FIG. 12 presents a block diagram illustrating an exemplary user-assignment table in an administrative device after the assignment of the application has been revoked from the user in accordance with the described embodiments.

FIG. 13 presents a block diagram illustrating an exemplary revocation message in accordance with the described embodiments.

FIG. 14 presents a block diagram illustrating an exemplary user-assignment table in a content provider device after the assignment of the application has been revoked from the user in accordance with the described embodiments.

FIG. 15 presents a flowchart illustrating a process for assigning an item of content to a user in accordance with the described embodiments.

FIG. 16 presents a flowchart illustrating a process for purchasing items of content for assignment in accordance with the described embodiments.

FIG. 17 presents a flowchart illustrating a process for revoking an assignment of an item of content from a user in accordance with the described embodiments.

In the figures, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

The data structures and code described in this detailed description can be stored on a computer-readable storage medium. The computer-readable storage medium can include any device or medium (or combination of devices and/or mediums) that can store data structures and code for use by a computer system or electronic device with computing capabilities. For example, the computer-readable storage medium can include volatile memory or non-volatile memory, including flash memory, random access memory (RAM, SRAM, DRAM, RDRAM, DDR/DDR2/DDR3 SDRAM, etc.), magnetic or optical storage mediums (e.g., disk drives, magnetic tape, CDs, DVDs), or other mediums capable of storing data structures or code. Note, however, that the computer-readable storage medium does not include non-statutory computer-readable storage mediums such as transitory signals.

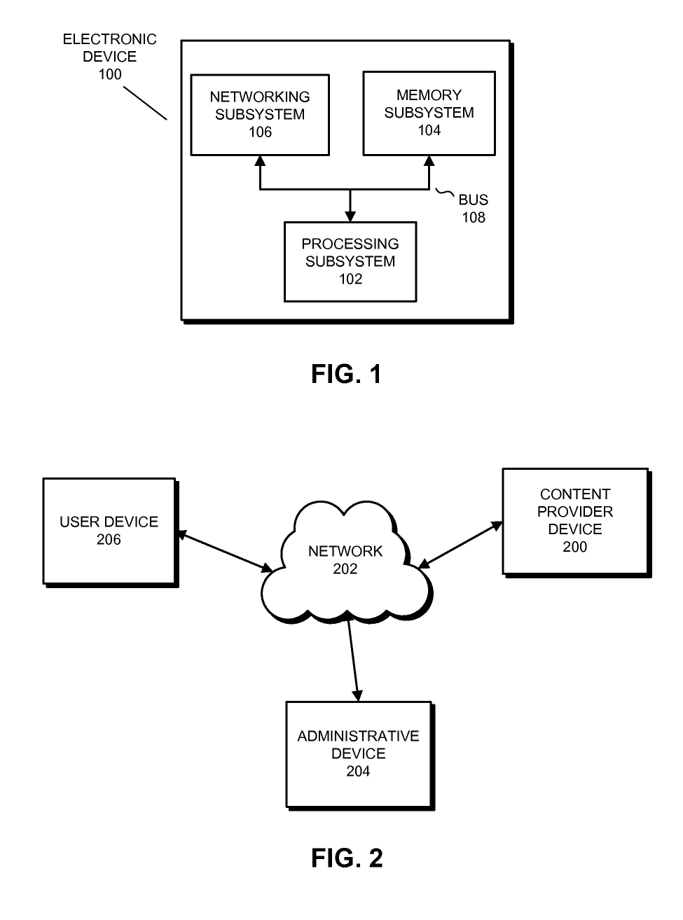

The methods and processes described in the following description can be embodied as program code that is stored in a computer-readable storage medium. When an electronic device with computing capabilities (see, e.g., electronic device 100 in FIG. 1) reads and executes the program code stored on the computer-readable storage medium, the electronic device performs the methods and processes in the program code stored in the computer-readable storage medium.

The methods and processes described in the following description can be included in hardware modules. For example, the hardware modules can include, but are not limited to, processors, application-specific integrated circuit (ASIC) chips, field-programmable gate arrays (FPGAs), and other devices. When the hardware modules are activated, the hardware modules perform the methods and processes included within the hardware modules. In some embodiments, the hardware modules include one or more general-purpose circuits that can be configured (e.g., by executing instructions) to perform the methods and processes. For example, in some embodiments, processing subsystem 102 (see FIG. 1) can acquire instructions from memory subsystem 104 and execute the instructions to cause processing subsystem 102 to perform the processes and operations in the described embodiments.

### Overview

The described embodiments include a content provider that enables a purchasing entity (e.g., a business, an institution, a user, etc.) to electronically purchase one or more items of content and assign the items of content to one or more users. The items of content can then be electronically transferred to the users to which they are assigned. For example, an employer can perform a transaction with a content provider device (e.g., a server, etc.) of the content provider to purchase a number of copies of an application for use by its employees. Next, the employer can send one or more assignment messages to the content provider device to indicate employees to which the purchased items of content are assigned. The content provider device can then electronically transfer the item of content to the user's device. For example, the user can sign in to an account with the content provider and download the item of content to the user's device, the item of content can be automatically sent from the content provider device to the user's device, etc. In a similar way, an institution such as a school, church, business, or government agency can purchase content items and assign them to one or more students, members, recipients, beneficiaries, and/or users. As a more general example, any user that can purchase items of content can purchase one or more items of content and can subsequently assign those items to any user for subsequent electronic transfer to that user.

In the described embodiments, the content provider can use a user's personal account information for electronically transferring items of content that have been assigned to the user by a purchasing entity. For example, assuming that the content provider is an electronic vendor of items of content such as digitally-rendered media files and applications, the user may maintain a personal account with the content provider that the user uses to acquire items of content for personal use. The personal account can be used by the content provider to electronically transfer items of content assigned to the user by a purchasing entity. For example, a user can log on to his personal account with the content provider, access a list of assigned items of content that is maintained by the content provider to determine available items of content for download, and thereafter download the assigned items of content. As another example, the content provider can use login names, email addresses, web addresses, directory names, etc. from the personal account to identify the user to whom items of content have been transferred and thereafter automatically transfer assigned items of content to a user.

Although the described embodiments enable the use of the user's personal account information for electronically transferring assigned items of content, the described embodiments include mechanisms for preventing a purchasing entity from accessing a user's personal account information. This can include preventing the purchasing entity from knowing even basic details such as the user's personal account login identifier. For example, in some embodiments, a purchasing entity uses a first identifier for the users (e.g., employee or student ids, membership numbers, etc.) to indicate to the content provider a user to which one or more items of content have been assigned, but can be unaware of personal account information (which is referred to herein as “a second identifier”). In these embodiments, the user can indicate to the content provider a mapping between the first identifier and the second identifier for the user (e.g., a personal account login name, a pseudonym/nickname for the user associated with the user's account, etc.). The first identifier can then be used to determine items of content assigned to the user and the second identifier can be used to electronically transfer the assigned items of content to the user.

In the described embodiments, the content provider can maintain a record of items of content that have been purchased by a purchasing entity. For example, the content provider can maintain a “purchased items” list that includes a listing of each purchased item of content along with an indication of how many of the purchased items of content remain to be assigned. The content provider can update the purchased items list each time one or more items of content (e.g., applications, digitally-encoded media files, etc.) have been purchased. When a purchasing entity subsequently indicates that one or more purchased items have been assigned to one or more users, the content provider can verify that the items of content are available for assignment using the purchased items list, and can adjust the number of items of content that remain to be assigned (e.g., when assigning the items of content to the indicated users).

In the described embodiments, the content provider can also maintain a record of users to whom items of content have been assigned. For example, in some embodiments, the content provider can maintain a “user-assignment” table that includes a number of entries, each of which includes information such as: (1) a first identifier for the user, (2) a second identifier for the user, and (3) an indication of items of content that have been assigned to the user. The content provider can update the user-assignment table when a purchasing entity indicates a change in the items of content assigned to one or more users.

For example, in the described embodiments, the purchasing entity can send an assignment message to the content provider that includes a first identifier for one or more users and a corresponding indication of one or more items of content that the purchasing entity would like assigned to each of the one or more users. After checking the purchased list to determine that the indicated items of content are available for assignment, the content provider uses the information from the assignment message to update an entry in the user-assignment table for each of the one or more users so that the entry includes a first identifier for the user and an indication of items of content that have been assigned to the user (recall that the purchasing entity generally does not have knowledge of the second identifier for the user). A given user can then send a user-identity message to the content provider that includes the first identifier for the user (which the user separately acquires from the purchasing entity) and a second identifier for the user. The content provider can then use the first identifier to find an entry for the user in the user-assignment table and can update the found entry to include the second identifier. As described above, the second identifier can then be used to electronically transfer the assigned items of content to the corresponding user.

In the described embodiments, the purchasing entity has the ability to indicate to the content provider when one or more items of content are no longer assigned to one or more users (i.e., when the assignment of one or more items of content is to be revoked). For example, the purchasing entity can send a revocation message that indicates that the assignment of one or more items of content is to be revoked. After an assignment of an item of content has been revoked, the content provider can limit various rights for the user with respect to the item of content. For example, the user may be unable to subsequently electronically transfer the item of content from the content provider device to the user's device or the content provider may provide limited or no services for the item of content (e.g., online operations for an application, etc.). Additionally (or alternatively), the content provider and/or a user's device may cause the item of content on the user's device to operate with reduced functionality, be wholly or partially un-updatable/unplayable/unreadable, be deleted, etc. depending on the configuration of the embodiment. For example, assuming that the item of content is an application that has been assigned by an employer to an employee, upon the employee no longer requiring use of the application, the employer may send a revocation message revoking the assignment of the application from the employee. The employer and/or the content provider may also send a message to the employee indicating that the application is no longer assigned to the employee. Additionally, upon revocation of the assignment, the content provider and/or the user's device may perform operations to cause the application to be deleted from the user's device, may partially or wholly disable the application on the user's device, may prevent updates of the application from being sent from the content provider to the user, may stop providing one or more services to the application, and/or may take other steps to ensure that the user loses one or more rights to the application.

By enabling the above-described operations (and the other operations herein described), the described embodiments can enable purchasing entities to retain at least some control over items of content that have been assigned to users. This enhanced control over the disposition of items of content may, in turn, prompt the wider adoption of volume purchases of items of content by larger purchasing entities.

### Electronic Device

FIG. 1 presents a block diagram illustrating an exemplary electronic device 100 in accordance with some embodiments. Generally, electronic device 100 can be any electronic device with computing capabilities that can perform the operations herein described. As can be seen in FIG. 1, electronic device 100 includes processing subsystem 102, memory subsystem 104, and networking subsystem 106.

Processing subsystem 102 includes one or more devices, circuits, hardware modules, and/or computer-readable storage mediums configured for performing computational operations. For example, processing subsystem 102 can include, but is not limited to, one or more processors/processor cores, ASICs, microcontrollers, or programmable-logic devices.

Memory subsystem 104 includes one or more devices, circuits, hardware modules, and/or computer-readable storage mediums for storing code and/or data for use by processing subsystem 102 and/or other subsystems in electronic device 100, as well as for controlling access to the code and/or data. For example, memory subsystem 104 can include, but is not limited to, DRAM, flash memory, and/or other types of memory.

In some embodiments, memory subsystem 104 includes some or all of a memory hierarchy that comprises an arrangement of one or more caches coupled to a memory in electronic device 100. In these embodiments, one or more of the caches in the memory hierarchy can be located in processing subsystem 102. In addition, in some embodiments, memory subsystem 104 is coupled to one or more high-capacity mass-storage devices (not shown). For example, memory subsystem 104 can be coupled to a magnetic or optical drive, a solid-state drive, or another type of mass-storage device. In these embodiments, memory subsystem 104 can store more recently and/or frequently accessed code and/or data, while the mass-storage device stores less recently and/or less frequently accessed code and/or data.

Networking subsystem 106 can include one or more devices configured to couple to and communicate on a wired and/or wireless network (i.e., to perform network operations). For example, networking subsystem 106 can include, but is not limited to, a Bluetooth networking system (including support for the BTLE standard), a cellular networking system (e.g., a 3G/4G network), a universal serial bus (USB) networking system, a networking system based on the standards described in Institute for Electrical and Electronic Engineers (IEEE) 802.11 (i.e., an 802.11 wireless network), an Ethernet networking system, or a wired or wireless personal-area networking (PAN) system (e.g., an infrared data association (IrDA), ultra-wideband (UWB), Z-Wave, or a network based on the standards described in IEEE 802.15).

Networking subsystem 106 can include controllers, radios/antennas for wireless network connections, sockets/plugs for hard-wired electrical connections, and/or other devices used for coupling to, communicating on, and handling data and events on a wired and/or wireless network. In some of these embodiments, networking subsystem 106 can include one or more mechanisms for forming an ad hoc network connection with other devices. In the following description, we refer to a subset of the mechanisms used for coupling to, communicating on, and handling data and events on the network at the physical layer of each network connection collectively as the “interface” for the corresponding network connection.

Bus 108 is coupled between processing subsystem 102, memory subsystem 104, and networking subsystem 106. Bus 108 comprises electrical, optical, and/or electro-optical connections used to communicate between processing subsystem 102, memory subsystem 104, networking subsystem 106. Note that bus 108 is presented for illustrative purposes, in alternative embodiments different numbers and/or arrangements of connections may be used.

Although shown as separate subsystems in FIG. 1, in some embodiments, some or all of a given subsystem can be integrated into one or more of the other subsystems in electronic device 100. For example, as described above, some or all of memory subsystem 104 can be included in processing subsystem 102.

Electronic device 100 can be, or can be incorporated into many different types of electronic devices. Generally, these electronic devices include any device that can perform the operations herein described. For example, electronic device 100 can be part of a desktop computer, a laptop computer, a server, a media player, an appliance, a subnotebook/netbook, a tablet computer, a smart phone, a network appliance, a set-top box, a toy, a controller, or another device.

Although specific components are used to describe electronic device 100, in some embodiments, different components and/or subsystems may be present in electronic device 100. For example, electronic device 100 may include one or more additional processing subsystems 102, memory subsystems 104, and/or networking subsystems 106. Alternatively, one or more of the subsystems may not be present in electronic device 100. Moreover, in some embodiments, electronic device 100 may include one or more additional subsystems that are not shown in FIG. 1. For example, electronic device 100 can include, but is not limited to, a display subsystem, a data collection subsystem, an audio subsystem, and/or an input/output (I/O) subsystem.

FIG. 2 presents a block diagram illustrating an exemplary content provider device 200 coupled via a network 202 to an administrative device 204 and a user device 206 in accordance with the described embodiments. Generally, content provider device 200, network 202, administrative device 204, and user device 206 are configured to perform the operations herein described.

Network 202 can be any wired or wireless network or combination of networks that enables content provider device 200, user device 206, and administrative device 204 to communicate with one another. For example, in some embodiments, network 202 comprises the Internet, possibly along with one or more of access points, local area networks, modems, routing hardware, etc. that can be used for content provider device 200, user device 206, and administrative device 204 to communicate with one another across the Internet. For instance, in some embodiments, network 202 comprises a local area network (e.g., a corporate local area network) that is communicatively coupled to the Internet, and user device 206 and administrative device 204 are coupled to the local area network and content provider device 200 is coupled to the Internet. In this embodiment, the devices can communicate with one another using the combination of the local area network and the Internet. In another embodiment, network 202 comprises a cellular network and a separate local area network that are communicatively coupled to the Internet, and user device 206 is coupled to cellular network, administrative device 204 is coupled to the local area network, and content provider device 200 is coupled to the Internet. In this embodiment, the devices can communicate with one another using the combination of the cellular network, the local area network, and the Internet.

In some embodiments, content provider device 200 is an electronic device that provides an electronic commerce (“e-commerce”) store/site that can be used for purchasing, assigning, managing, and electronically transmitting items of content. In some embodiments, content provider device 200 is an electronic device such as electronic device 100 (with the attendant subsystems). For example, in some embodiments, content provider device 200 comprises at least one server computer system (and can, as a part of a computing “cloud,” comprise multiple computer systems). In some embodiments, content provider device 200 provides an application store or “app store” such as the App Store from Apple, Inc. of Cupertino, Calif.

Administrative device 204 is an electronic device that provides an administrative user (e.g., a purchasing agent, an administrator, a manager, etc.) an interface (e.g., an application, a website, etc.) to the e-commerce store/site hosted by content provider device 200. The interface can be used for performing operations that can include purchasing items of content, assigning purchased items of content and revoking assignments of purchased items of content, administering/reviewing purchased and assigned items of content and other account details, and for performing other tasks to enable the operations herein described. In some embodiments, administrative device 204 is an electronic device such as electronic device 100 (with the attendant subsystems). For example, in some embodiments, administrative device 204 comprises a desktop computer system, a tablet computer, or a smart phone.

User device 206 is an electronic device that provides a user with an interface (e.g., an application, a website, etc.) to the e-commerce store/site hosted by content provider device 200. The interface can be used for performing operations that can include logging in to an account, communicating a user identity message, requesting and accepting an electronic transfer (e.g., download, email, manual transfer, etc.) of assigned items of content, administering/reviewing assigned items of content and other account details, and for performing other tasks to enable the operations herein described. In some embodiments, user device 206 is an electronic device such as electronic device 100 (with the attendant subsystems). For example, in some embodiments, user device 206 comprises a desktop computer system, a tablet computer, or a smart phone.

Although we show and describe content provider device 200, network 202, administrative device 204, and user device 206 in FIG. 2, in some embodiments, the devices may be in a different arrangement and/or may comprise a different number of devices. For example, in some embodiments, administrative device 204 is comprised of two devices: a first purchasing device and a second administrative device. In this embodiment, the purchasing device can be used by a purchasing agent to purchase one or more items of content and the administrative device can be separately used by an administrator to assign/revoke assignment of the purchased items of content. Generally, the described embodiments can comprise any arrangement of devices that can perform the operations herein described.

### Items of Content

In the described embodiments, the items of content provided by content provider (via content provider device 200) can comprise any type of items of content that can be purchased by a purchasing entity (e.g., administrative user, a user, etc.) and assigned to a user. For example, items of content can include, but are not limited to, applications, digitally-encoded media files such as music, books/periodicals/writing, images, video, etc., ring tones, licensed content, digitally-encoded plans/specifications, and/or combinations of these.

In some embodiments, items of content can be electronically transferred using network 202 from content provider device 200 to user's device 206. In some embodiments, items of content can otherwise be transferred from a content provider to user's device 206 (e.g., manually transferred, sent via email or regular mail).

### Assigning an Item of Content to a User

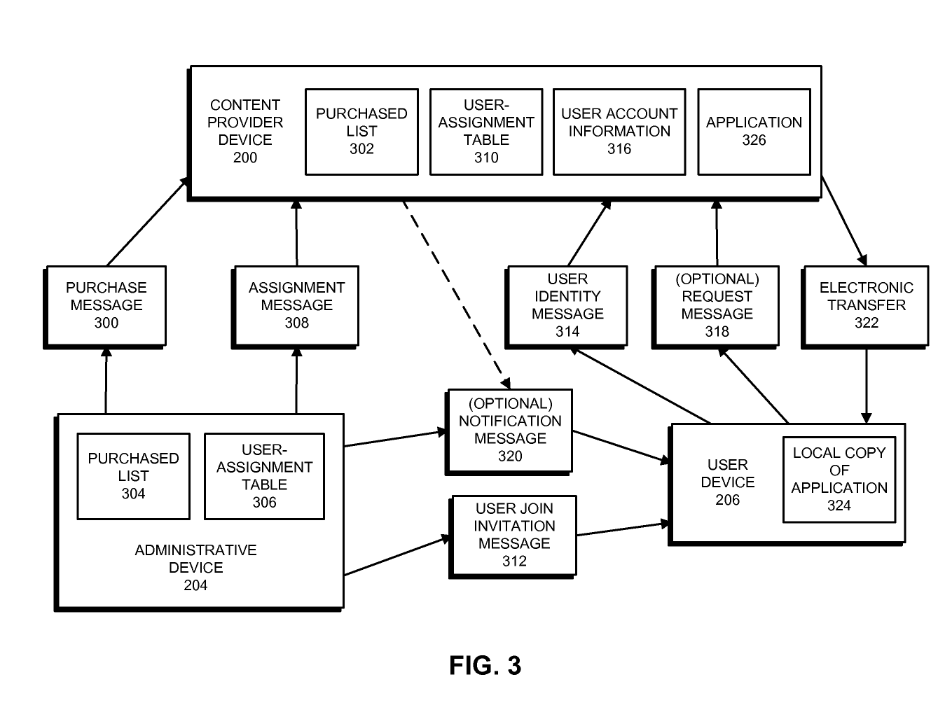

FIG. 3 presents a block diagram illustrating exemplary messages communicated between content provider device 200, administrative device 204, and user device 206 while assigning an item of content to a user in accordance with the described embodiments. In the example shown in FIG. 3, an application 326 is used as an exemplary item of content. However, as described above, the described embodiments are operative with any item of content that can be purchased and assigned to a user.

The messages shown in FIG. 3 can commence when administrative device 204, during a purchase transaction with content provider device 200, sends a purchase message 300 to content provider device 200 that indicates that an administrative user of administrative device 204 wishes to purchase a copy of application 326. For example, the administrative user of administrative device 204 can use the interface (e.g., application, website, etc.) to the e-commerce store/site hosted by content provider device 200 purchase a copy of a word processing application, a game application, a scientific computing application, etc from the content provider that operates content provider device 200. Purchase message 300 can comprise information regarding application 326, account information for the administrative user, remittance information, and other information useful for the purchase transaction.

Note that purchase message 300, along with the other messages shown in FIG. 3, can be formatted/arranged in accordance with a communication standard used for communicating between the sender (e.g., administrative device 204) and the receiver (e.g., content provider device 200). This can mean that each message can be configured as a payload in one or more packets/data units/frames that are transmitted across network 202 from the sender to the receiver. The arrangement of packets for transmission between devices is generally known in the art and hence is not described in detail.

In response to purchase message 300, content provider device 200 can complete the purchase transaction for application 326. At the conclusion of the purchase transaction (which can involve operations such as verifying the form of payment, sending a receipt, etc.), content provider device 200 can add application 326 to purchased list 302 associated with the administrative user's account. Purchased list 302 can be, for example, a listing in a file, a data structure, a variable in memory, etc., that includes a listing of each item of content purchased by the administrative user along with a number of the item of content that remain available for assignment. Thus, after the above-described purchase transaction is complete, purchased list 302 comprises a listing of application 326 and a value that indicates that at least one copy of application 326 is available for assignment.

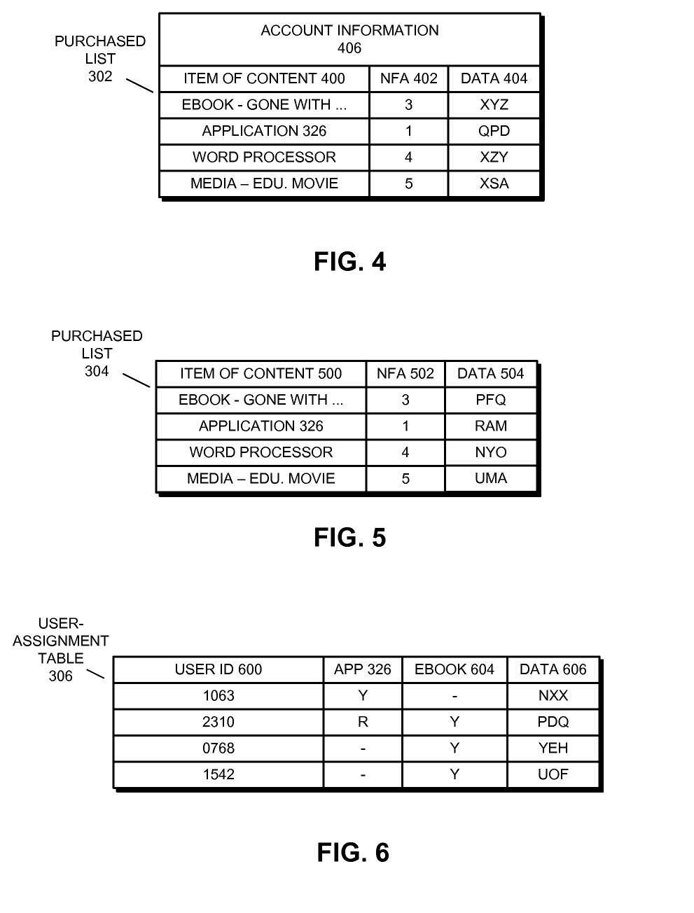

FIG. 4 presents a block diagram illustrating an exemplary purchased list 302 in accordance with the described embodiments. As can be seen, purchased list 302 comprises a listing of account information 406 for the administrative user's account, a listing of each item of content 400 along with a number 402 of the items of content that remain available for assignment (“NFA”), and other data 404 relevant to the listing. In the example shown in FIG. 4, the items of content include an ebook (a digitally-rendered book), application 326, a word processor application, and a media file (an educational movie). For these items of content, there are 3, 1, 4, and 5 available to assign, respectively. Data 404 for these items in the figure is simply illustrative, but in an actual embodiment, data 404 can comprise any useful data (e.g., item of content identifiers, numbers of items of content previously purchased, date items of content were purchased, license status, item of content information, etc.) and can be organized as multiple separate fields for each entry.

In some embodiments, administrative device 204 maintains a local copy of purchased list 302 that an administrative user can view in the interface (e.g., application, website, etc.) to the e-commerce store/site hosted by content provider device 200 (or can otherwise view) to review purchased items of content that are available for assignment. The local copy of purchased list 302 is shown in administrative device 204 in FIG. 3 as purchased list 304. In these embodiments, after the purchase transaction is complete, administrative device 204 can update purchased list 304 to reflect the purchase of application 326. FIG. 5 presents a block diagram illustrating an exemplary purchased list 304 in accordance with the described embodiments. As can be seen, purchased list 304 comprises a listing of each item of content 500 along with a number 502 of the items of content that remain available for assignment (“NFA”), and other data 504 relevant to the listing. In the example shown in FIG. 5, purchased list 304 has similar listings to purchased list 302 (because the purchase transaction has been completed), so that the items of content include an ebook, application 326, the word processor application, and the media file. For these items of content 500, there are 3, 1, 4, and 5 available to assign, respectively. Data 504 for these items in the figure is simply illustrative, but in an actual embodiment, data 504 can comprise any useful data (e.g., e.g., item of content identifiers, numbers of items of content previously purchased, date items of content were purchased, license status, item of content information, etc.) and can be organized as multiple separate fields for each entry. Depending on the implementation, purchased list 304 may also include account information similar to account information 406 in purchased list 302.

After the purchase transaction is completed, the administrative user, as part of an assignment transaction, can use the interface on administrative device 204 to review purchased list 304 and can perform an assignment operation in the interface to assign application 326 to a desired user. More specifically, using the interface the administrative user can perform one or more operations to instruct administrative device 204 that application 326 listed in the purchased list 304 is to be assigned to a user that is identified using a first identifier. In response, administrative device 204 can update an entry (i.e., make a new entry for the user or update an existing entry for the user) in user-assignment table 306 so that the updated entry lists the user by the first identifier for the user, as well as listing application 326 as being assigned to the user. FIG. 6 presents a block diagram illustrating an exemplary user-assignment table 306 in administrative device 204 in accordance with the described embodiments. As can be seen in FIG. 6, user assignment table 306 comprises a column for user ids 600, two columns for items of content, and a column for data 606. Each entry in the column of user ids 600 comprises a first identifier for the user for which the entry contains information (shown in FIG. 6 using an illustrative 4-digit number). As described above, the first identifier for the user can include any identifier used by an administrative user to distinguish one user from another. For example, the first identifier can be an employee or student id, a membership number, some or all of the user's name, etc. The columns for items of content include the exemplary items of content app 326 and ebook 604. These columns includes records of the assignment of a corresponding item of content (where app 326 can be the same as application 326 in purchased list 304 and ebook 604 can be the same “ebook” in purchased list 304). In the columns below app 326 and app 604, a “-” entry represents an item of content that has not been assigned to a corresponding user, a “R” entry represents an item of content for which a previous assignment has been revoked, and a “Y” entry represents an item of content that is assigned to the corresponding user. Data 606 for these items in the figure is illustrative, but in an actual embodiment, data 606 can comprise any useful data (e.g., user name/address/information, numbers of given items of content previously assigned, dates the items of content were assigned, item of content license status, item of content identifiers/information, etc.) and can be organized as multiple separate fields for each entry.

Note that the “R,” or revoked, state shown in FIG. 6 and the other figures may not be used in some embodiments. For example, some embodiments may use the “-” or not-assigned, state in places where the revoked state is shown in FIG. 6 and the other figures.

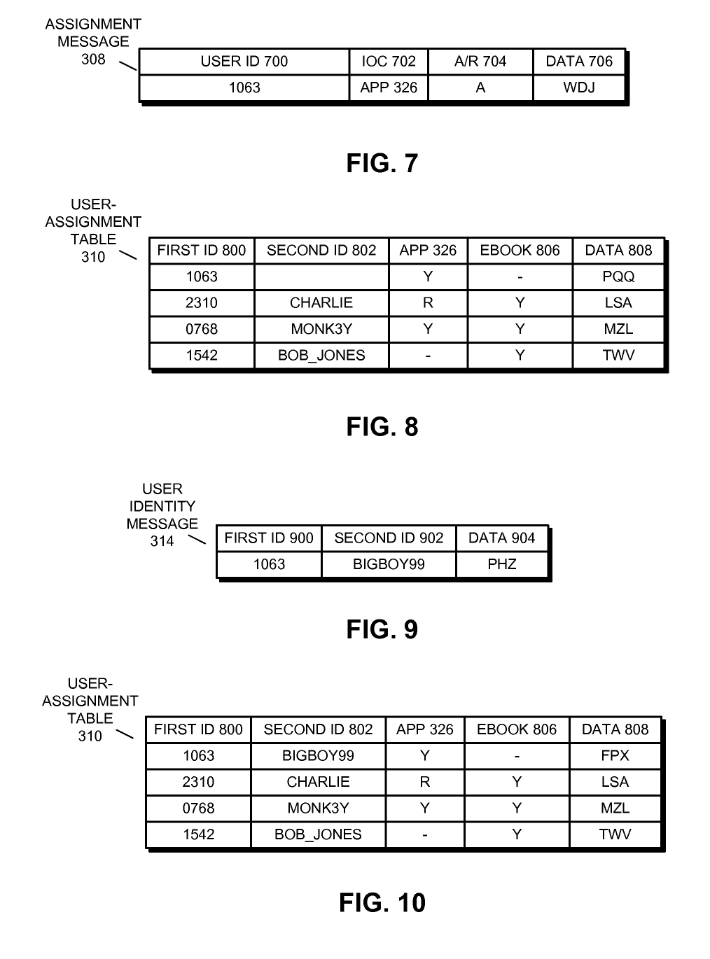

In addition, as part of the assignment transaction, after the administrative user instructs administrative device 204 that application 326 listed in the purchased list 304 is to be assigned to the user, administrative device 204 sends assignment message 308 to content provider device 200 to inform content provider device that application 326 is to be assigned to the user. FIG. 7 presents a block diagram illustrating an exemplary assignment message 308 in accordance with the described embodiments. Assignment message 308 comprises a user identifier (user ID) 700, an item of content (IOC) 702 listing, an assigned/revoked (A/R) 704 indicator, and data 706. Assignment message 308 sent from administrative device 204 includes the first identifier for the user in user ID 700 (shown by the exemplary string “1063” in FIG. 7), an identifier for application 326 in IOC 702 (shown by the exemplary string “APP 326” in FIG. 7), an indication that application 326 is being assigned in A/R 704 (shown by the exemplary string “A” in FIG. 7), and any other relevant data in data 706 (e.g., number previously purchased, date purchased, license status, item information, etc.), which is illustrated using the exemplary string “WDJ.”

Upon receiving and processing assignment message 308, content provider device 200 can update an entry (i.e., make a new entry for the user or update an existing entry for the user) in user-assignment table 310 so that the updated entry lists the user by the first identifier for the user, as well as listing application 326 as being assigned to the user. FIG. 8 presents a block diagram illustrating an exemplary user-assignment table 310 from content provider device 200 in accordance with the described embodiments. As can be seen in FIG. 8, user assignment table 310 comprises a column for a first identifier for the user (first ID) 800, column for a second identifier for the user (second ID) 802, two columns for items of content, and a column for data 808. Each entry in the column of first IDs 800 comprises a first identifier for the user for which the entry contains information (shown in FIG. 8 using an illustrative 4-digit number). Each entry in the column of second IDs 802 comprises a second identifier for the user. The columns for items of content include the exemplary items of content app 326 and ebook 802. These columns include records of the assignment of a corresponding item of content (where app 326 can be the same as application 326 in purchased list 302 and ebook 806 can be the same “ebook” in purchased list 302). The meanings of the various values in the columns below app 326 and ebook 806 are described above in the description of user-assignment table 306. Data 808 for these items in the figure is simply illustrative, but in an actual embodiment, data 808 can comprise any useful data (e.g., number previously assigned, date assigned, license status, item information, etc.) and can be organized as multiple separate fields for each entry.

Note that, although FIG. 8 shows a single user-assignment table 310, in some embodiments, more than one table can be used. For example, in some embodiments, a separate table maps first ID 800 to second ID 802, and a second table maps second ID 802 to assigned items of content. Generally, any arrangement of tables can be used to perform the operations herein described, and are collectively referred to herein as a “user-assignment table.” Additionally, in some embodiments, user-assignment table 306 maintained by administrative device 204 is a local copy of user-assignment table 310 that an administrative user can view in the interface (e.g., application, website, etc.) to the e-commerce store/site hosted by content provider device 200 (or can otherwise view) to review the assignments of items of content.

As can be seen in FIG. 8, second ID 802 for the user to which application 326 is being assigned, and whose first ID 800 is “1063,” is blank in user-assignment table 310. FIG. 8 is shown this way to illustrate that, in some embodiments, the administrative user may not know the user's second ID 802 (which can be, e.g., a login name, a nickname, etc. known to the content provider). Hence, even though content provider device 200 is able to fill in most of the remaining values in the entry from the information in the assignment message, second ID 802 (and perhaps some or all of data 808) may not be filled until the user sends a message to the content provider to inform the content provider of the mapping/relationship between first ID 800 for the user and second ID 802. Once the user informs the content provider of the mapping/relationship between first ID 800 for the user and second ID 802, content provider device 200 can fill in second ID 802 in the entry for the user (and may also be able to fill in some or all of data 808 based on information associated with the user that can be accessed using second ID 802).

In some embodiments, in order to fill the second ID 802 entry in the user-assignment table 310, the administrative user can, either before or after sending assignment message 308, instruct administrative device 204 to send a user join invitation message 312 to user device 206 (or can otherwise inform the user of the information in the user join invitation message 312). User join invitation message 312 comprises an indication that the user should inform the content provider of a relationship/mapping between the first identifier for the user and the second identifier for the user (i.e., inform the content provider of a second identifier for the user that can be associated with the first identifier for the user).

In response to the user join invitation message 312, the user can use the interface (e.g., application, website, etc.) to the e-commerce store/site hosted by content provider device 200 on user device 206 to send a user identity message 314 to content provider device 200. FIG. 9 presents a block diagram illustrating an exemplary user identity message 314 in accordance with the described embodiments. As can be seen in FIG. 9, user identity message 314 comprises a first identifier (first ID) 900, a second identifier (second ID) 902, and data 904. First ID 900 comprises the first identifier for the user and second ID 902 comprises the second identifier for the user. Data 904 in the figure is simply illustrative, but in an actual embodiment, data 904 can comprise any data useful for the user identity message and can be organized as multiple separate fields.

Content provider device 200, upon receiving user identity message 314, can use information from user identity message 314 to update second ID 802 in an entry for the user in user-assignment table 310. For example, content provider device 200 can use first ID 900 for the user to find a matching first ID 800 in user-assignment table 310, and can update the corresponding entry with second ID 902. FIG. 10 presents a block diagram illustrating an exemplary user-assignment table 310 following the update of the entry for the user in accordance with the described embodiments. As can be seen in FIG. 10, the entry for the user (whose first ID 800 is “1063”) in user-assignment table 310 has been updated so that second ID 802 is set to the exemplary user login name “BIGBOY99.” Note that exemplary data 808 has also been updated to the string “FPX” illustrate that content provider device 200 may update the data associated with the entry based on the second ID 802 (which may give content provider device 200 insight into user account details, etc.).

Note that, in some embodiments, content provider device 200 may perform one or more authentication operations before using the user identity message 314 to update user-assignment table 310. For example, in some embodiments, an authentication process comprises administrative device 204 transferring some kind of a secret (e.g., a digital certificate, a password, a nonce, etc.) to content provider device 200. Content provider device 200 can then store the secret with an indication that the secret is associated with the administrative device 204. Administrative device 204 can then also transfer the secret to one or more authorized user devices 206. In these embodiments, user device 206 sends the secret along with the user identity message 314 (or during a separate authentication step (not shown)), and content provider device 200 compares the secret to the stored secret as an authentication step before allowing the use of the user identity message 314 to update user-assignment table 310. In some embodiments, the secret is unique to a particular scope of use, e.g., a given transaction, time/date range, and/or user device and may expire or be invalidated outside that scope. In some embodiments, the secret can be a general secret that is used for authenticating all user devices 206 associated with administrative device 204.

In some embodiments, after completing the assignment transaction and the user identity transaction (which comprises user join invitation message 312 and user identity message 314), content provider device 200 can update user account information 316 to comprise an indication that application 326 has been assigned to the user. For example, in some embodiments, content provider device 200 can update a record of purchased or assigned applications in the user's account to include application 326. In these embodiments, the application may be presented in the interface to the e-commerce store/site hosted by content provider device 200 on user device 206 in a similar way as applications previously purchased by the user for personal use. Using the interface on user device 206, the user can review the record of purchased or assigned applications. After reviewing the record of purchased or assigned applications (and seeing application 326 listed therein), the user can send request message 318 to content provider device 200 from user device 206 to electronically transfer 322 (e.g., download) application 326 from content provider device 200.

In some embodiments, after completing the assignment transaction and the user identity transaction, administrative device 204 and/or content provider device 200 can send a notification message 320 to user device 206 to inform the user of the assignment of application 326 to the user. Generally, notification message 320 can comprise any arrangement and/or type of information sufficient to convey to the user that application 326 has been assigned. For example, notification message 320 can be a push message sent to user device 206, an email, etc. that includes information about assigned application 326. In these embodiments, upon receiving notification message 320, using user device 206, the user can review the record of purchased or assigned applications using the interface to the e-commerce store/site hosted by content provider device 200. After reviewing the record of purchased or assigned applications, the user can send request message 318 to content provider device 200 from user device 206 to electronically transfer 322 (e.g., download) application 326 from content provider device 200. In these embodiments, because notification message 320 is sent to the user, the user may know more quickly that application 326 has been assigned and hence is available for electronic transfer.

Note that request message 318 is marked as “optional” in FIG. 3. In some embodiments, the user may not be required to send request message 318. For example, the user can configure user account settings so that items of content, upon assignment, are downloaded to user device 206 automatically (e.g., the next time that user device 206 is synched, plugged in to a wall power outlet, is idle, and/or meets one or more additional qualifications for automatic download).

After downloading, a local copy of the application 324 can be installed and otherwise made available for use on user device 206. As described below, in some embodiments, some or all of the functions (as well as the install itself) of application 326 can be controlled by the administrative user.

Although a number of messages is shown and described above, the messages are simplified for illustrating exemplary operations that may be performed by the described embodiments. In some embodiments, the messages communicated between the devices are different in number or arrangement. For example, in some embodiments, any of the messages may actually be comprised of multiple separate messages between a sender and a receiver of the message (e.g., requests, responses, control communications, acknowledgements, denials, resends, etc.). As another example, messages not shown in FIG. 3 may be used to enable a given transaction (e.g., the purchase transaction, the assignment transaction, etc.), including messages communicated to one or more devices (e.g., authentication devices, etc.) that are not shown in FIG. 3. Generally, any number of messages (or sub-messages) may be communicated to enable the operations herein described. As a yet another example, some or all of the messages may contain more information such as message type information, sender/receiver information, error checking codes, timestamps, etc.

Although various records (e.g., purchased list 302, user-assignment table 306, user-assignment table 310, etc.) are described with respect to FIG. 3, alternative embodiments include different numbers, types, or formats of the records. For example, in some embodiments, purchased list 302 and user-assignment table 310 maintained by content provider device 200 can be part of a single data structure associated with an account for the administrative user of administrative device 204. As another example, user-assignment table 306 and user-assignment table 310 can include any number of columns listing individual items of content. Generally, any form of records can be maintained by any of the devices that enables the operations herein described.

Revoking an Item of Content that is Assigned to a User

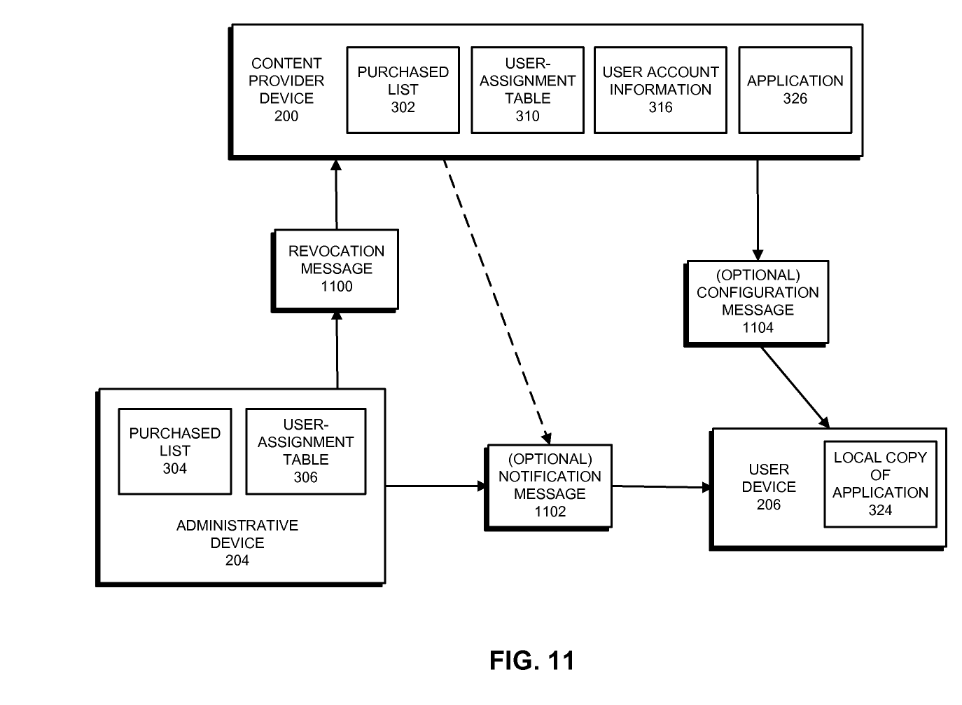

FIG. 11 presents a block diagram illustrating exemplary messages communicated between content provider device 200, administrative device 204, and user device 206 while revoking the assignment of application 326 to the above-described user in accordance with the described embodiments. In the example shown in FIG. 11, application 326 is used as an exemplary item of content. However, as described above, the described embodiments are operative with any item of content that can be purchased and assigned to a user.

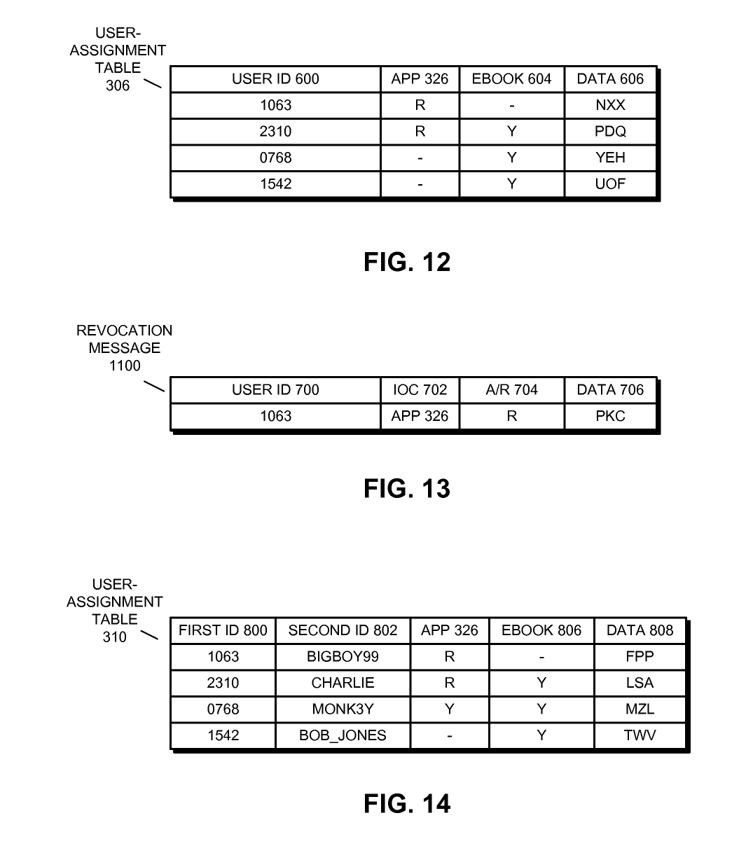

The messages shown in FIG. 11 can commence when an administrative user of administrative device 204, as part of an assignment revocation transaction, uses the interface on administrative device 204 to review user-assignment table 306 and perform an assignment revocation operation to revoke the assignment of application 326 from the user (which is assumed to have previously been assigned to the user, e.g., as described above with respect to FIGS. 3-10). More specifically, using the interface, the administrative user can perform one or more operations to instruct administrative device 204 that the assignment of application 326, which is listed in user-assignment table 306 as being assigned to the user, is to be revoked from the user. In response, administrative device 204 can update the entry for the user in user-assignment table 306 so that the updated entry, which lists the user by the first identifier for the user, lists the assignment of application 326 as having been revoked from the user. Alternatively, administrative device 204 can remove or otherwise disable/invalidate the entry for the user in user-assignment table 306. FIG. 12 presents a block diagram illustrating an exemplary user-assignment table 306 after the assignment of the application has been revoked from the user in accordance with the described embodiments. As can be seen, and in contrast to the same entry in user-assignment table 306 shown in FIG. 6, the listing for the user (identified as “1063”) indicates that the assignment has been revoked (shown using the letter “R” in the entry).

As part of the assignment revocation transaction, after the administrative user instructs administrative device 204 that the assignment of application 326 is to be revoked from the user, administrative device 204 sends revocation message 1100 to content provider device 200 to inform content provider device that the assignment of application 326 is to be revoked from the user. FIG. 13 presents a block diagram illustrating an exemplary revocation message 1100 in accordance with the described embodiments. Revocation message 1100 sent from administrative device 204 includes the first identifier for the user in user ID 700 (shown by the exemplary string “1063” in FIG. 11), an identifier for application 326 in IOC 702 (shown by the exemplary string “APP 326” in FIG. 11), an indication that the assignment of application 326 is being revoked in A/R 704 (shown by the exemplary string “R” in FIG. 11), and any other relevant data in data 706 (e.g., number previously purchased, date purchased, license status, item information, etc.,) which is illustrated using the exemplary string “PKC.”

Note that revocation message 1100, along with the other messages shown in FIG. 11, can be formatted/arranged in accordance with a communication standard used for communicating between the sender (e.g., administrative device 204) and the receiver (e.g., content provider device 200). This can mean that each message can be configured as a payload in one or more packets/data units/frames that are transmitted across network 202 from the sender to the receiver. The arrangement of packets for transmission between devices is generally known in the art and hence is not described in detail.

Assuming that application 326 can be reassigned following the assignment revocation transaction, as part of the assignment revocation transaction, administrative device 204 can update purchased list 304 to show that the revoked copy of application 326 is now available for assignment to a user. This can include updating an indicator for an existing entry in purchased list 304 to indicate that the copy of application 326 is available for assignment.

Upon receiving and processing revocation message 1100, content provider device 200 can update an entry in user-assignment table 310 so that the updated entry lists the assignment of application 326 as having been revoked from the user. FIG. 14 presents a block diagram illustrating an exemplary user-assignment table 310 after the assignment of the application has been revoked from the user in accordance with the described embodiments. As can be seen, and in contrast to the same entry in user-assignment table 310 shown in FIG. 10, the listing for the user (identified as “1063”) indicates that the assignment has been revoked (shown using the letter “R” in the entry). As described above, the use of the “R,” or revoked, state may be replaced by the use of the “-,” or not-assigned, state in some embodiments.

Assuming that application 326 can be reassigned following the assignment revocation transaction, as part of the assignment revocation transaction, content provider device 200 can update purchased list 302 to show that the revoked copy of application 326 is now available for assignment to a user. This can include updating an indicator for an existing entry in purchased list 302 to indicate that the copy of application 326 is available for assignment.

In some embodiments, after completing the assignment revocation transaction, administrative device 204 and/or content provider device 200 can send a notification message 1102 to user device 206 to inform the user of the revocation of the assignment of application 326. Generally, notification message 1102 comprises any arrangement and/or type of information sufficient to convey to the user that the assignment of application 326 has been revoked. For example, notification message 1102 can be a push message sent to user device 206, an email, etc. that includes information about the revocation of the assignment of application 326 to the user.

In some embodiments, upon receiving revocation message 1100, content provider device 200 can send one or more configuration messages 1104 to user device 206 to disable or block features of and/or uninstall some or all of local copy of application 324. In some of these embodiments, a user of user device 206 can have previously agreed to remote management of the local copy of application 324 on user device 206; thereby enabling such operations. However, in alternative embodiments, content provider device 200 is unable to perform operations on local copy of application 324 on user device 206, and instead performs operations to block future electronic transfers of the item of content from content provider device 200 to user device 206 and/or not providing content-provider services related to the item of content (which is described in more detail below).

Although a number of messages is shown and described above, the messages are simplified for illustrating exemplary operations that may be performed by the described embodiments. In some embodiments, the messages communicated between the devices are different in number or arrangement. For example, in some embodiments, any of the messages may actually be comprised of multiple separate messages between a sender and a receiver of the message (e.g., requests, responses, control communications, acknowledgements, denials, resends, etc.). As another example, messages not shown in FIG. 11 may be used to enable a given transaction (e.g., the purchase transaction, the assignment transaction, etc.), including messages communicated to one or more devices (e.g., authentication devices, etc.) that are not shown in FIG. 11. Generally, any number of messages (or sub-messages) may be communicated to enable the operations herein described. As a yet another example, some or all of the messages may contain more information such as message type information, sender/receiver information, error checking codes, timestamps, etc.

Although various records (e.g., purchased list 302, user-assignment table 306, user-assignment table 310, etc.) are described with respect to FIG. 11, alternative embodiments include a different numbers, types, or formats of the records. For example, in some embodiments, purchased list 302 and user-assignment table 310 maintained by content provider device 200 can be part of a single data structure associated with an account for the administrative user of administrative device 204. As another example, user-assignment table 306 and user-assignment table 310 can include any number of columns listing individual items of content. Generally, any form of records can be maintained by any of the devices that enables the operations herein described.

Assigning Items of Content to and Revoking Items of Content from Multiple Users

The examples shown in FIGS. 3-14 describe an embodiment where a single item of content (application 326) is assigned to a single user (in FIGS. 3-10) and then revoked from the same user (in FIGS. 11-14). However, in the described embodiments, the assignment of content items to and the revocation of content items from users occurs on a larger scale (and, in some cases, on a significantly larger scale). More specifically, in some embodiments, the administrative user purchases two or more items of content (e.g., 2 copies of an application, 3 copies of a first application and 5 copies of a second application, 12 copies of a digitally-rendered movie, or 300 copies of a digitally-rendered book, etc.), assigns the two or more items of content to one or more users, and subsequently revokes one or more of the assignments of the items of content from given users.

For example, an administrative user in a corporation can purchase 50 copies of a first application (e.g., a word processor application) and 30 copies of a second application (e.g., a scientific computing application) from the content provider. The administrative user can then instruct the content provider that 30 copies of the first application are to be assigned to 30 employees designated by the administrative user (e.g., employees within a given department of the corporation, managerial employees, etc.), and 25 copies of the second application are to be assigned to 25 employees designated by the administrative user. (In this example, depending on how the administrative user wishes to assign applications, some of the employees can be assigned copies of both the first and second applications.) The employees can then electronically transfer the assigned copy(ies) of the first and/or second applications from the content provider to corresponding user devices. At a subsequent time, the administrative user can revoke the assignment of one or more copies of the first and/or second applications from given employees (e.g., when the employee quits, changes job functions, no longer needs the application, is terminated, etc.).

Accordingly, in some embodiments, the messages and records shown in FIGS. 3-14 can be configured to include the additional information used to enable an administrative user to make assignments to multiple users and revoke assignments from multiple users. For example, purchased lists 302 and 304 can include more entries to enable keeping records for more items of content, and user assignment tables 306 and 310 can include more entries to enable keeping records for more users and can include more columns for items of content. As another example, assignment message 308 and revocation message 1100 can include more entries to enable the assignment/revocation messages to carry information about assignments to multiple users and/or revocation of assignment from multiple users from administrative device 204 to content provider device 200.

Note that the described embodiments can be scaled to enable an administrative user to purchase any reasonable number of items of content (e.g., applications for students, etc.) and easily—using the above-described interface—perform assignments and revocations, sometimes for large groups of users (e.g., students in a class, employees in a department, etc.) at the same time. For example, in some embodiments, the administrative user can simply select a group of items of content in the interface, and can then select a group of users to which the items of content are to be assigned. The system can then undertake the underlying operations (as described for the single user in FIGS. 3-14) for the group of users.

### Controlling Users' Rights to Items of Content

As indicated above, in the described embodiments, administrative users retain at least some control over items of content that are installed on user's devices. Specifically, administrative users can revoke assignments of items of content, thereby leading to at least some loss of rights for the user with regard to the item of content. The loss of rights for the user with regard to an item of content can be manifested in various ways, depending on the nature of the item of content and amount of control that the administrative user is given over items of content on a user's device.

In some embodiments, the administrative user does not have control over items of content that are already installed on user's devices. In these embodiments, therefore, despite revoking the assignment of an item of content, the administrative user generally cannot cause a user's device to perform operations on an item of content (e.g., uninstall/delete, block/disable, etc.). Hence, the administrative user can be limited to causing the content provider to perform operations such as blocking future electronic transfers of the item of content to the user's device and/or not providing content-provider services related to the item of content. The content-provider services can comprise any services related to the item of content, including updating/upgrading, support, online/dynamic features, re-installing/re-downloading (a lost or corrupted item of content) and/or other content-provider services associated with the item of content. For example, assuming that the assigned item of content is an application that has been installed on a user's device, following the revocation of the assignment by the administrative user, the application may remain on the user's device and may remain at least partially functional, but the content provider can stop providing: online features of the application, updates/upgrades to the application, reinstallation of the application, application-related information (e.g., calendar updates, dynamically-generated content, push messages, etc.) to the application, etc.

In embodiments where the administrative user does not have control over items of content that are already installed on user's devices, the revocation of the assignment of an item of content can cause any of a number of different indications to the user that the assignment has been revoked. For example, content provider device 200 and/or administrative device 204 can send notification message 1102 (e.g., an email, a push message, etc.) that indicates that the assignment of the item of content has been revoked, and thus the user has lost the corresponding rights to the item of content. As another example, content provider device 200 can update user account information 316 to indicate that the assignment has been revoked. For instance, user account information 316 may comprise a list of items of content that are available for electronic transfer to the user's device and/or for which the content provider will provide services. In these embodiments, the user can access and review user account information 316 using the interface (e.g., application, website, etc.) to the e-commerce store/site hosted by content provider device 200 that is presented by user device 206. In the list, items of content for which an assignment have been revoked may be presented with an indication that rights have been revoked and/or that the user can restore some or all of the revoked rights to the item of content by purchasing a personal copy of the item of content.

In some embodiments, the administrative user may have been granted at least some control over items of content that are already installed on user devices. For example, user device 206 can communicate one or more messages (e.g., within request message 318, etc.) to content provider device 200 that include an indication that one or more items of content that have been assigned to the user can be controlled by content provider device 200 (e.g., at the request of the administrative user). As another example, user account information 316 may include information that indicates that any items that meet a given set of qualifications (e.g., appearing in user-assignment table 310, being assigned to the user by a third party, etc.) can be controlled by content provider device 200 (e.g., at the request of the administrative user). In these embodiments, upon receiving revocation message 1100 revoking the assignment of an item of content, content provider device 200 can cause user device 206 to perform corresponding operations on the item of content (e.g., uninstall, delete, disable, etc.).

In embodiments where items of content on a user's device 206 are acted on by content provider device 200 following the revocation of the assignment, at least one of content provider device 200 and the administrative device 204 can send any of a number of different indications to the user that the assignment has been revoked. For example, content provider device 200 and/or administrative device 204 can send notification message 1102 indicating that the assignment of the item of content has been revoked, along with an indication of the action to be taken on the item of content, and possibly an indication of options for the user to avoid the action and/or reverse the action (e.g., a deadline by which the user can purchase the item of content to avoid deletion/disabling, etc.). As another example, content provider device 200 can update user account information 316 to indicate that the assignment has been revoked and hence the item was acted upon on the user's device. For instance, user account information 316 may comprise a list of items of content that are available for electronic transfer to the user's device. In these embodiments, the user can access and review user account information 316 using the interface (e.g., application, website, etc.) to the e-commerce store/site hosted by content provider device 200 that is presented by user device 206. In the list, items of content for which an assignment have been revoked may be presented with an indication that the assignment of the item of content has been revoked, along with an indication of the action to be taken on the item of content, and possibly an indication of options for the user to avoid the action and/or reverse the action (e.g., a deadline by which the user can purchase the item of content to avoid deletion/disabling, etc.).

In some embodiments, a user's device 206 can include mechanisms for partially or completely disabling and/or blocking access to an item of content on the user's device 206. For example, the user's device can include one or more tokens, code libraries, certificates, timer values, etc. that are incorporated in and/or associated with an item of content that has been assigned to the user. In these embodiments, when an assignment has been revoked, the mechanism(s) can be activated or otherwise used to limit the user's rights with respect to the item of content. For example, assuming that the item of content is associated with a timer value, the user's device 206 could check the timer value before allowing the user to access/use the item of content (or some feature of the item of content). When the timer expires, the user's device 206 may need to contact content provider device 200 to get the timer reset. When the assignment of the item of content has been revoked, the content provider device 200 could refuse to reset the timer.

### Processes for Handling the Assignment and Revocation of Assignment of Items of Content

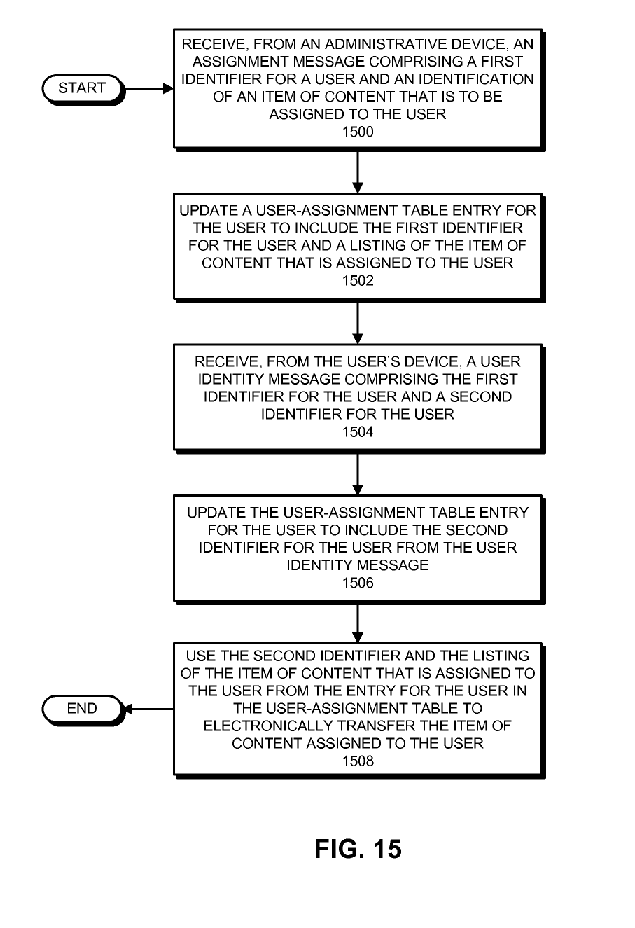

FIG. 15 presents a flowchart illustrating a process for assigning an item of content in accordance with the described embodiments. In the example shown in FIG. 15, an administrative user assigns a single user an item of content. However, as described above, the described embodiments function similarly in cases where the administrative user assigns two or more users two or more items of content. In addition, although certain operations in FIG. 15 are presented in a given order as an illustration of some embodiments, alternative embodiments include a different number of operations and/or perform the operations in a different order. Generally, any number of operations can be performed that enable the assignment of an item of content to a user such as herein described.

The process shown in FIG. 15 starts when content provider device 200 receives, from administrative device 204, an assignment message 308 comprising a first identifier for a user and an identification of an item of content that is to be assigned to the user (step 1500). For example, assuming that the item of content is a copy of a digitally-rendered book and that the administrative user is a pastor at a church who is assigning a copy of the digitally-rendered book to a member of the church, content provider device 200 can receive, from administrative device 204 operated by the pastor, an assignment message 308 comprising a first identifier for a member of the church (e.g., a member name or number) and an identification of the digitally-rendered book that is to be assigned to the user.

Content provider device 200 then updates a user-assignment table 310 entry for the user to include the first identifier for the user and a listing of the item of content that is assigned to the user (step 1502). Continuing the example above, this operation comprises using information from the assignment message 308 to update an entry in user-assignment table 310 to include the member name or number for the user and the identification of the digitally-rendered book that is to be assigned to the user. Note that an entry for the user may already exist in user-assignment table 310 because the user was previously assigned some item of content; in this case, the existing entry (which will already include the first identifier for the user) can simply be updated to include the identification of the digitally-rendered book that is to be assigned to the user.

Next, content provider device 200 receives, from the user's device 206, a user identity message 314 comprising the first identifier for the user and a second identifier for the user (step 1504). Continuing with the example above, this operation comprises receiving a user identity message 314 with the above-described the member name or number for the user, as well as a user account identifier that identifies the user's account with the content provider (e.g., a login name or nickname), which is the second identifier for the user.

Content provider device 200 then, based on the first identifier for the user in the user identity message, updates the user-assignment table entry for the user to include the second identifier for the user from the user identity message (1506). Continuing with the example above, this operation comprises using information from user identity message 314 to update an entry in user-assignment table 310 for the user to include the user's login name. By doing this, content provider device 200 creates a mapping between the member name provided by the administrative user and an account that will eventually be used to electronically transfer the digitally-rendered book to the user's device. Note that, in some embodiments, the administrative user does not know the second identifier for the user, and hence the user provides this information. Additionally note that the receipt of the user identity message 314 may have occurred before the receipt of assignment message 308, and the values from the earlier user identity message 314 can have been used to update or establish the entry for the user in user-assignment table 310.

Next, content provider device 200 uses the second identifier and the listing of the item of content that is assigned to the user from the entry for the user in user-assignment table 310 to electronically transfer, from the server to the user's device, the item of content assigned to the user (step 1508). Continuing with the example above, this operation comprises the content provider device 200 using the entry for the church member from the user-assignment table 310 to determine the user's login name (or other personal account information), and then using the user's login name (or other personal account information) to determine how to electronically transfer the digitally-rendered book to the user.

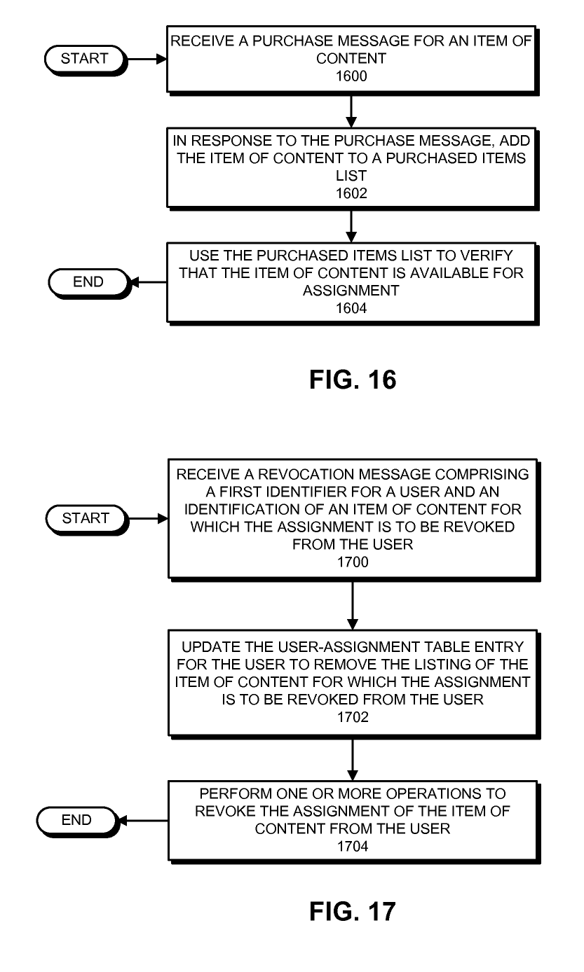

FIG. 16 presents a flowchart illustrating a process for purchasing items of content for assignment in accordance with the described embodiments. The operations shown in FIG. 16 can occur before (the purchase) and during (the verification) the operations shown in FIG. 15. In addition, although certain operations in FIG. 16 are presented in a given order as an illustration of some embodiments, alternative embodiments include a different number of operations and/or perform the operations in a different order. Generally, any number of operations can be performed that enable the assignment of an item of content to a user such as herein described.

The operations shown in FIG. 16 start when content provider device 200 receives, from a purchasing device, a purchase message 300 for the item of content (step 1600). Continuing the example above, content provider device 200 can receive, from a purchasing device/computer operated by a secretary at the church, a purchase message indicating that the digitally-rendered book is to be purchased. Note that the purchasing device can be a device separate from the administrative device, but may not be (the same is true for the administrative user and the purchasing user that operates the purchasing device—these may be different users, but are not in some embodiments). For example, the church may have a purchasing user that operates a first computer system to make purchases and an administrative user that operates a second computer system to perform assignments of items of content and other tasks. In response to purchase message 300, content provider device 200 adds the item of content to a purchased list 302 (step 1602). Next, when performing the assignment operation in FIG. 15, content provider device 200 uses the purchased items list to verify that the item of content is available for assignment (step 1604).

FIG. 17 presents a flowchart illustrating a process for revoking an assignment of an item of content in accordance with the described embodiments. In the example shown in FIG. 17, an administrative user revokes the assignment of a single item of content from a user. However, as described above, the described embodiments function similarly in cases where the administrative user revokes the assignment of two or more items of content from two or more users. In addition, although certain operations in FIG. 17 are presented in a given order as an illustration of some embodiments, alternative embodiments include a different number of operations and/or perform the operations in a different order. Generally, any number of operations can be performed that enable the revocation of the assignment of an item of content to a user such as herein described.

The operations shown in FIG. 17 start when content provider device 200 receives, from administrative device 204, a revocation message 1100 comprising a first identifier for a user and an identification of an item of content for which the assignment is to be revoked from the user (step 1700). Continuing the example above, content provider device 200 can receive from administrative device 204 operated by the pastor of the church an revocation message 1100 indicating that the assignment of the digitally-rendered book to the above-described member of the church is to be revoked.

Content provider device 200 then updates the user-assignment table 310 entry for the user to remove the listing of the item of content for which the assignment has been revoked from the user (step 1702). Next, content provider device 200 performs one or more operations to revoke the assignment of the item of content from the user (step 1704). As described above, these operations can include any operation permitted by the particular implementation for revoking assignments of items of content, thereby leading to at least some loss of rights for the user with regard to the item of content. The loss of rights for the user with regard to an item of content can be manifested in various ways, depending on the nature of the item of content and amount of control that the administrative user is given over items of content on a user's device.

### Business Rules and Digital Rights Management

In some embodiments, there may be business rules and/or digital rights that apply to certain content items. For example, an a digitally-encoded music file or book, may not be revocable and/or may not be assigned to a user with anything other than full ownership rights. In these embodiments, content provider device 200 may be configured to enforce the business rules and/or digital rights that change from time to time. In these embodiments, a request to assign an item of content and/or to revoke the assignment of an item of content that violates the business rules and/or the digital rights can be rejected by content provider device 200, depending on a current state of the business rules and digital rights. The rejection can be applied to requests made by administrative device 204 and/or user device 206.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments.

What is claimed is:

1. A method for assigning items of content to users, comprising:
in a content provider device, performing operations for:
receiving, from an administrative device, an assignment message comprising a first identifier for a user and an identification of at least one item of content from a set of items of content that is assigned to the user;
updating a user-assignment table entry for the user to include the first identifier for the user and a listing of the at least one item of content from the set of items of content that is assigned to the user;
receiving, from the user's device, a user identity message comprising the first identifier for the user and a second identifier for the user;
updating the user-assignment table entry for the user to include the second identifier for the user from the user identity message based on the first identifier for the user in the user identity message; and
using the second identifier and the listing of the at least one item of content that is assigned to the user from the user-assignment table entry for the user to electronically transfer, from the content provider device to the user's device, the at least one item of content assigned to the user.

2. The method of claim 1, further comprising:
in the content provider device, performing operations for, prior to updating a user-assignment table entry for the user to include the listing of the at least one item of content from the set of items of content that is assigned to the user:
receiving, from a purchasing device, a purchase message for the set of items of content;
in response to the purchase message, creating a record of purchased items of content in the set of items of content, each purchased item of content in the set of items of content being separately assignable; and
using the record of purchased items of content to verify that the at least one item of content is available for assignment.

3. The method of claim 1, further comprising:
in the content provider device, performing operations for:
receiving, from the administrative device, a revocation message comprising a first identifier for a user and an identification of at least one item of content for which the assignment is to be revoked from the user;
updating the user-assignment table entry for the user to remove the listing of the at least one item of content for which the assignment is to be revoked from the user; and
performing one or more operations to revoke the assignment of the item of content from the user.

4. The method of claim 3, wherein performing one or more operations to revoke the assignment of the item of content from the user comprises:
sending a reporting message to the user's device, the reporting message causing the user's device to display a message indicating that the at least one item of content is no longer assigned to the user.

5. The method of claim 3, wherein performing one or more operations to revoke the assignment of the item of content from the user comprises:
no longer providing services for the item of content for which the assignment was revoked from the user's device.

6. The method of claim 3, wherein the at least one item of content comprises an application that performs a number of functions on the user's device, and wherein performing one or more operations to revoke the assignment of the item of content from the user comprises:
sending a disabling message to the user's device, the disabling message causing the user's device to one of:
disable some or all of the functions performed by the application; or
remove the application from the user's device.

7. The method of claim 1, wherein:
the first identifier for the user is an administrative identifier for the user; and
the second identifier for the user is an account identifier for the user.

8. The method of claim 1, wherein the administrative device and the user's device are different devices.

9. The method of claim 1, further comprising:
in the content provider device, performing operations for:
before using the second identifier and the listing of the at least one item of content that is assigned to the user from the user-assignment table entry for the user to electronically transfer, from the content provider device to the user's device, the at least one item of content assigned to the user:
receiving, from the user's device, a request to electronically transfer, to the user's device, items of content that are assigned to the user, the request identifying the user by the second identifier for the user.

10. The method of claim 1, wherein the set of items of content includes at least one instance of at least one of:
an application; or
a digitally-rendered media file.

11. A method for operating a user device, comprising:
in the user device, performing operations for:
sending, to a content provider device, a user identity message comprising a first identifier for the user and a second identifier for the user; and
receiving, from the content provider device, at least one item of content that has been assigned to a user of the user device, the item of content being identified as being assigned to the user using the second identifier and a listing of the at least one item of content that is assigned to the user from a user-assignment table entry for the user in the content provider device.

12. The method of claim 11, further comprising, before receiving, from the content provider device, the at least one item of content:
in the user device, performing operations for:
sending a request to electronically transfer, to the user's device, items of content that are assigned to the user, the request identifying the user by the second identifier for the user; and
receiving, from the content provider device, the at least one item of content in response to the request message.

13. The method of claim 11, further comprising, before receiving, from the content provider device, the at least one item of content:
in the user device, performing operations for:
receiving one or more notification messages that the at least one item of content has been assigned to the user of the user device.

14. The method of claim 11, further comprising:
in the user device, performing operations for:
upon revocation of the assignment of an item of content, receiving a reporting message, the reporting message causing the user's device to display a message indicating that the at least one item of content is no longer assigned to the user of the user device, the revocation of the item of content causing the loss of one or more rights of the user with regard to the item of content.

15. The method of claim 11, wherein the at least one item of content comprises an application that performs a number of functions on the user device, and wherein the method further comprises:
in the user device, performing operations for:
upon revocation of the assignment of the application, receiving a disabling message, the disabling message causing the user's device to one of:
disable some or all of the functions performed by the application; or
remove the application from the user's device.

16. The method of claim 11, further comprising, before sending, to the content provider device, the user identity message:
in the user device, performing operations for:
receiving a user join invitation message from an administrative device; and
sending the user identity message in response to the user join invitation message.

17. The method of claim 11, wherein:
the first identifier for the user is an administrative identifier for the user; and
the second identifier for the user is an account identifier for the user.

18. The method of claim 11, wherein the at least one item of content comprises at least one of:
an application; or
a digitally-rendered media file.

19. A method for assigning items of content, comprising:
in an administrative device, performing operations for:
sending an assignment message to a content provider device, the assignment message comprising a first identifier for a user and an identification of at least one item of content from a set of items of content that is assigned to the user.

20. The method of claim 19, further comprising, before sending the assignment message to the content provider device:
in the administrative device, performing operations for:
sending, to the content provider device, a purchase message for the set of items of content.

21. The method of claim 19, further comprising:
in the administrative device, performing operations for:
sending, to the content provider device, a revocation message comprising a first identifier for a user and an identification of at least one item of content for which the assignment is to be revoked from the user, the revocation message causing the content provider device to perform one or more operations to revoke the assignment of the item of content from the user.

22. The method of claim 19, wherein the set of items of content includes at least one instance of at least one of:
an application; or
a digitally-rendered media file.

23. The method of claim 19, further comprising, after sending the assignment message to the content provider device:
in the administrative device, performing operations for:
sending one or more notification messages to a user device indicating that the at least one item of content has been assigned to the user of the user device.

24. The method of claim 19, further comprising,
in the administrative device, performing operations for:
sending a user join invitation message to the user device, the user join invitation message indicating that the user device should send a user identity message to the content provider device that identifies a mapping between the first identifier for the user and a second identifier for the user, the second identifier used by the content provider device to electronically transfer the at least one assigned item of content to the user device.

25. The method of claim 24, wherein:
the first identifier for the user is an administrative identifier for the user; and
the second identifier for the user is an account identifier for the user.
